(19) United States
(12) Patent Application Publication
(10) Pub. No.: US 2008/0012435 A1
(43) Pub. Date: Jan. 17, 2008

(54) Magnetic motion apparatus

(76) Inventor: Hans Tiemann, Beatrice, NE (US)

Correspondence Address: SUITER SWANTZ PC LLO, 14301 FNB PARKWAY, SUITE 220, OMAHA, NE, 68154, US

(21) Appl. No.: 11/823,110

(22) Filed: Jun. 26, 2007

Related U.S. Application Data
(60) Provisional application No. 60/816,527, filed on Jun. 26, 2006.

(51) Int. Cl. H02K 7/00; H02K 35/00; H02K 37/00

(52) U.S. Cl. 310/46; 310/80

(57) ABSTRACT

The present invention is a magnetic motion apparatus for conversion of energy. Magnetic motion apparatus of the present invention may include a stator having a frame, a rotor rotationally coupled with the frame, the rotor having a first end including a cam and a second end including a plurality of magnets fixedly attached to the rotor and a plurality of levers pivotally connected to the frame surrounding the rotor, each one of the plurality of levers having a first end including a roller adjacent to the cam, and a second end including a magnet. The plurality of magnets fixedly attached to the rotor may be arranged so that ends of the plurality of magnets and the magnets of the levers are repelled by one another creating rotational motion of the rotor whereby energy is converted.

### CROSS-REFERENCE TO RELATED APPLICATIONS

The present application claims the benefit under 35 U.S.C. §119(e) of U.S. Provisional Application Ser. No. 60/816,527, filed Jun. 26, 2006. Said U.S. Provisional Application Ser. No. 60/816,527 is herein incorporated by reference in its entirety.

### FIELD OF THE INVENTION

The present invention generally relates to the field of magnet motors, and more particularly to a magnetic motion apparatus.

### BACKGROUND OF THE INVENTION

Many modern devices require electrical energy to perform their desired function. Additionally, many modern devices rely on motion devices to perform their intended function. For example, appliances such as fans, power tools, washing machines, air conditioners and the like rely upon motion devices for their intended function.

Conventional motion devices convert electrical energy into mechanical energy, commonly referred as motors, and convert mechanical energy into electrical energy, commonly referred as generators. Conventional motion devices operate according to electromagnetism principles whereby a mechanical force is produced by a magnetic field. Conventional motion devices are rotary devices whereby a rotating part, referred as a rotor, rotates in comparison to a stationary part, referred as a stator.

Conventional motion devices are limited by a number of factors. Many conventional motion devices, such as motors, require an electric source. Additionally, many conventional motion devices are limited by low efficiency with respect to output, size, weight and cost. Consequently, an improved magnetic motion apparatus is necessary.

### SUMMARY OF THE INVENTION

Accordingly, the present invention is directed to a magnetic motion apparatus for conversion of energy. Magnetic motion apparatus of the present invention may comprise a a stator having a frame, a rotor rotationally coupled with the frame, the rotor having a first end including a cam and a second end including a plurality of magnets fixedly attached to the rotor and a plurality of levers pivotally connected to the frame surrounding the rotor, each one of the plurality of levers having a first end including a roller adjacent to the cam, and a second end including a magnet. The plurality of magnets fixedly attached to the rotor may be arranged so that ends of the plurality of magnets and the magnets of the levers are repelled by one another creating rotational motion of the rotor whereby energy is converted.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 depicts a cut-away side view of a magnetic motion apparatus in accordance with an embodiment of a present invention;

FIG. 2 depicts a perspective view of the interrelationship of the lever and rotor of the magnetic motion apparatus in accordance with an embodiment of the present invention;

FIG. 3 depicts components of the lever and rotor of the magnetic motion apparatus magnetic motion apparatus in accordance with an embodiment of the present invention;

FIG. 4 depicts a lever in accordance with an embodiment of the present invention;

FIG. 5 depicts a side view of a cam in accordance with an embodiment of the present invention;

FIG. 6 depicts a top view of a cam in accordance with an embodiment of the present invention;

FIG. 7 depicts a perspective view of the magnetic motion apparatus in accordance with an embodiment of the present invention;

FIG. 8 depicts exemplary rotary motion of the rotor in comparison to the stator in accordance with an embodiment of the present invention;

FIG. 9 depicts the variable radial projection of the cam in accordance with an embodiment of the present invention;

FIG. 10 depicts the variable radial projection of the cam in comparison with the repulsion of the levers creating rotation of the cam in accordance with an embodiment of the present invention;

FIGS. 11A-11G depicts exemplary rotary motion of the rotor and the offset position of levers to provide continuous rotational force in accordance with an embodiment of the present invention;

FIG. 12 depicts a top view of a magnetic motion apparatus in accordance with an alternative embodiment of the present invention;

FIG. 13 depicts a side view of a magnetic motion apparatus in accordance with an alternative embodiment of the present invention;

FIG. 14 depicts a top view of a magnetic motion apparatus in accordance with a second alternative embodiment of the present invention;

FIG. 15 depicts a side view of a magnetic motion apparatus in accordance with a second alternative embodiment of the present invention; and

FIG. 16 depicts a top view of a magnetic motion apparatus in accordance with a third alternative embodiment.

### DETAILED DESCRIPTION OF THE INVENTION

Reference will now be made in detail to the presently preferred embodiments of the invention, examples of which are illustrated in the accompanying drawings.

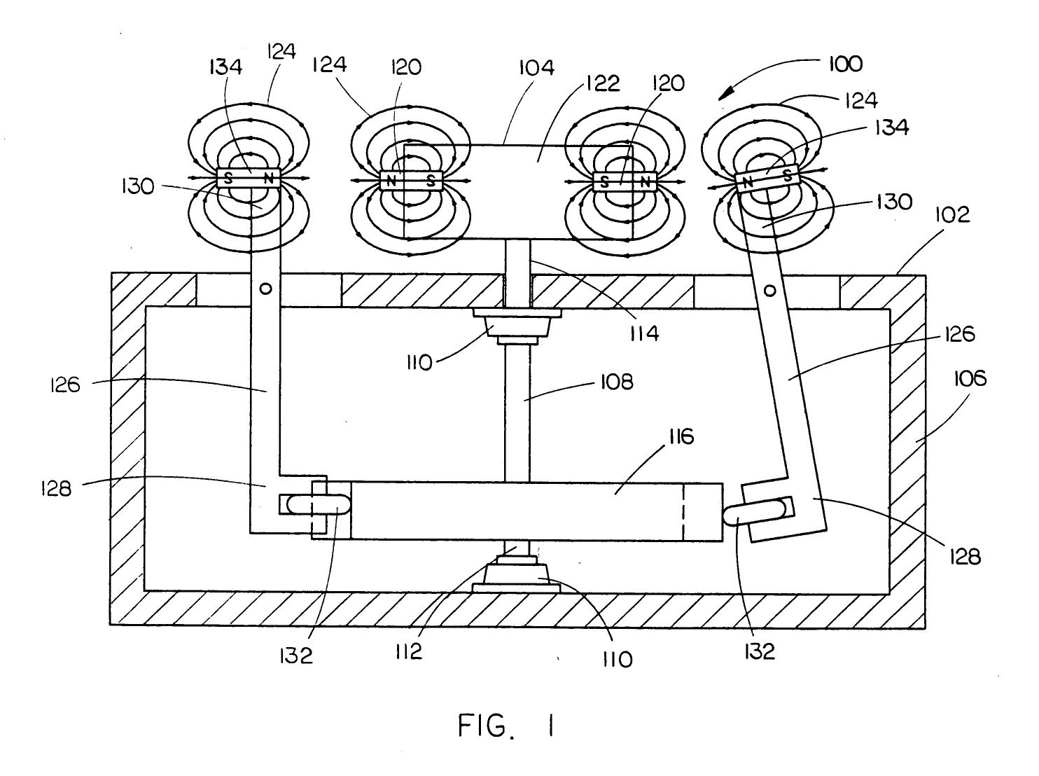

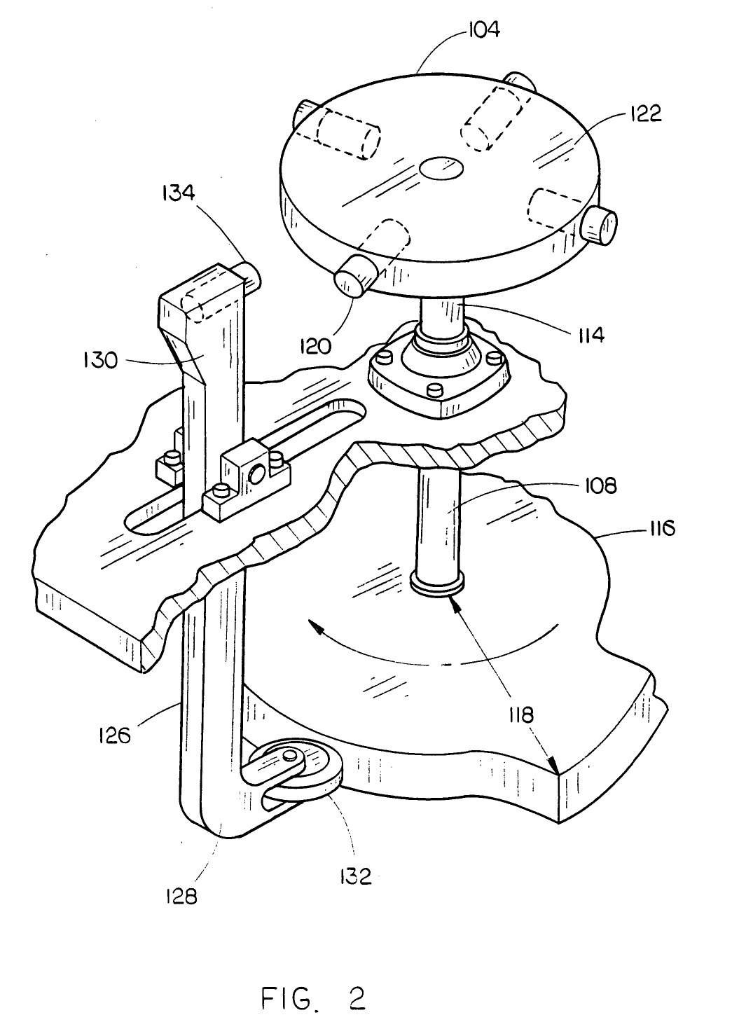

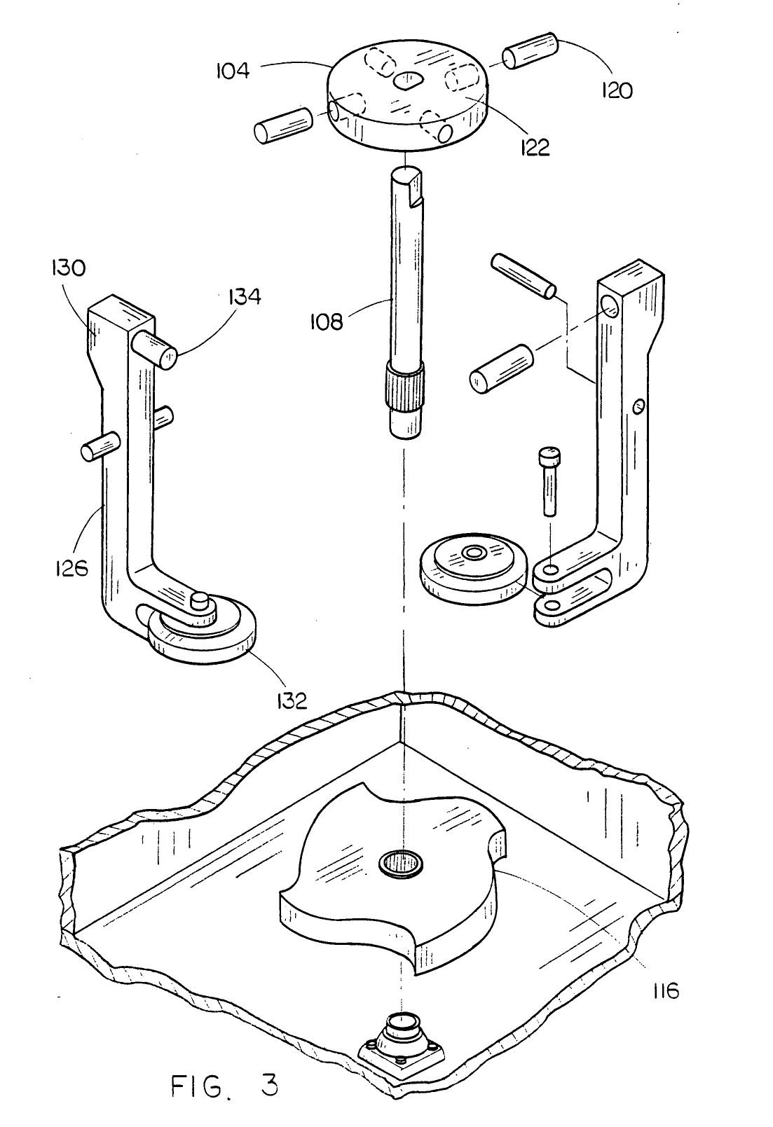

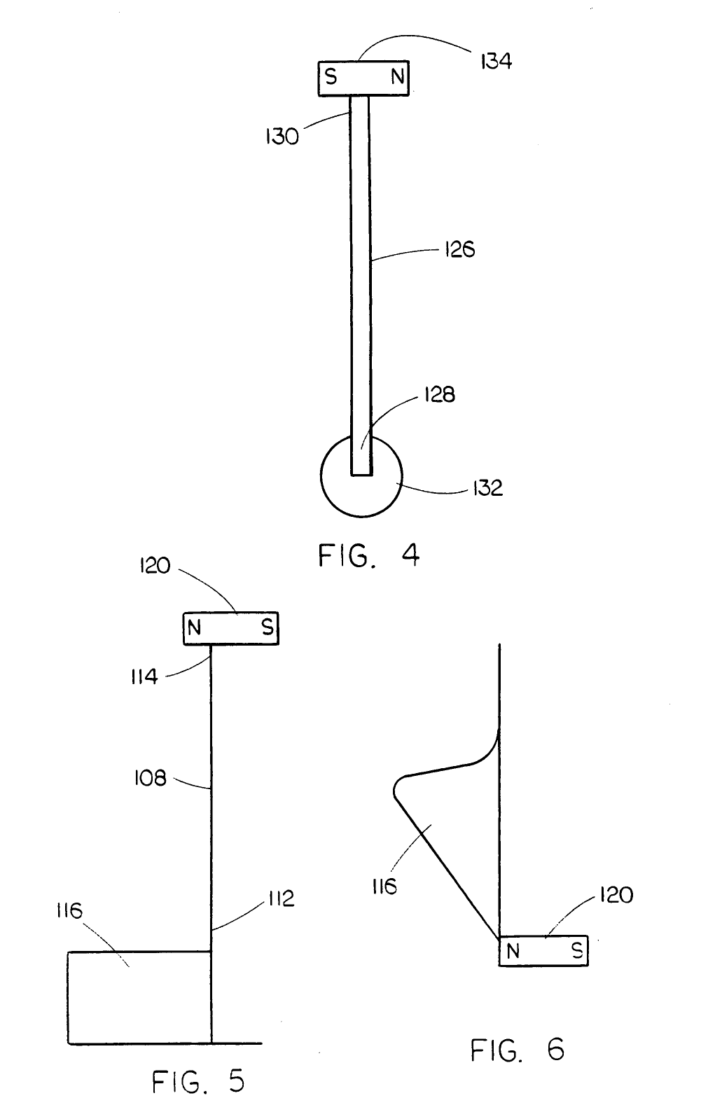

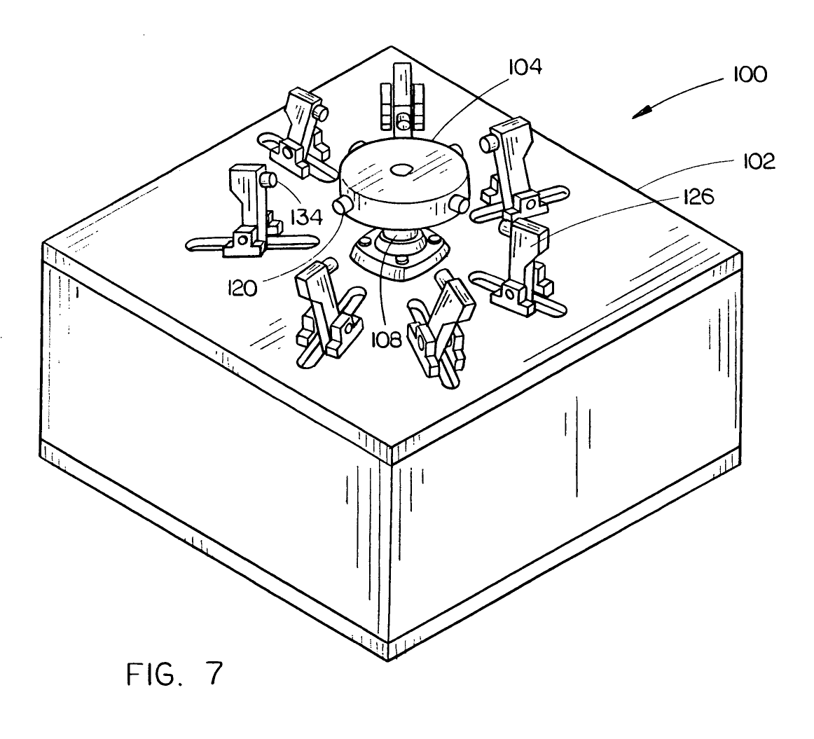

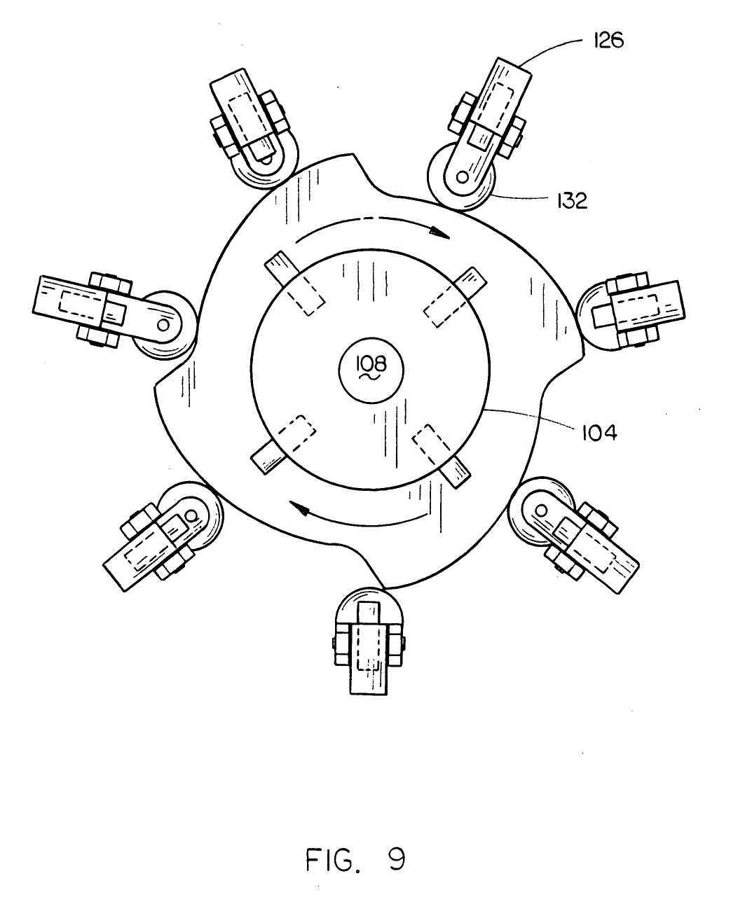

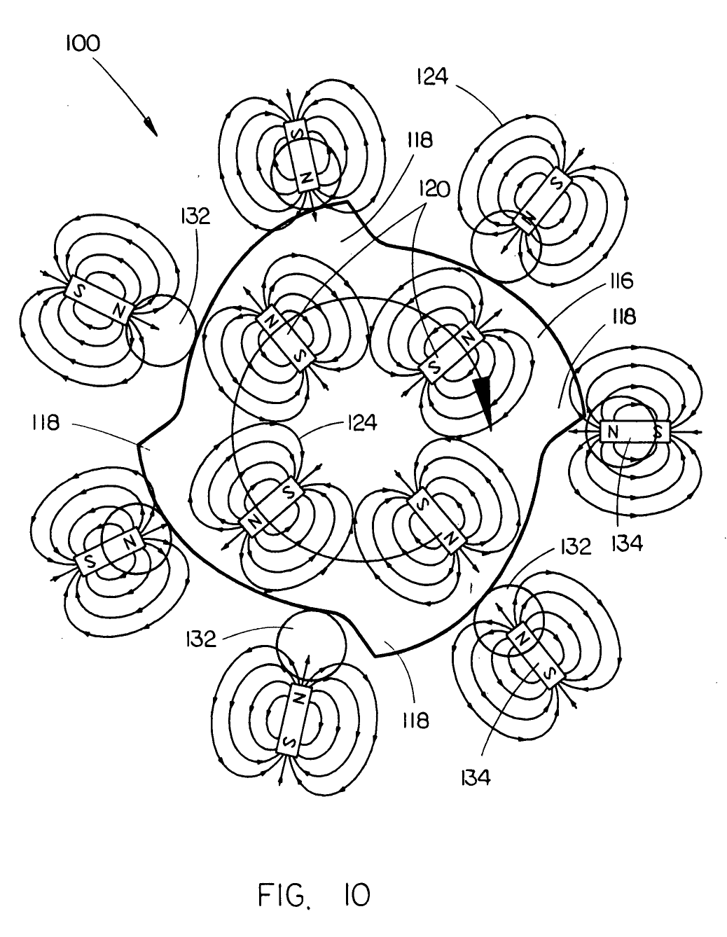

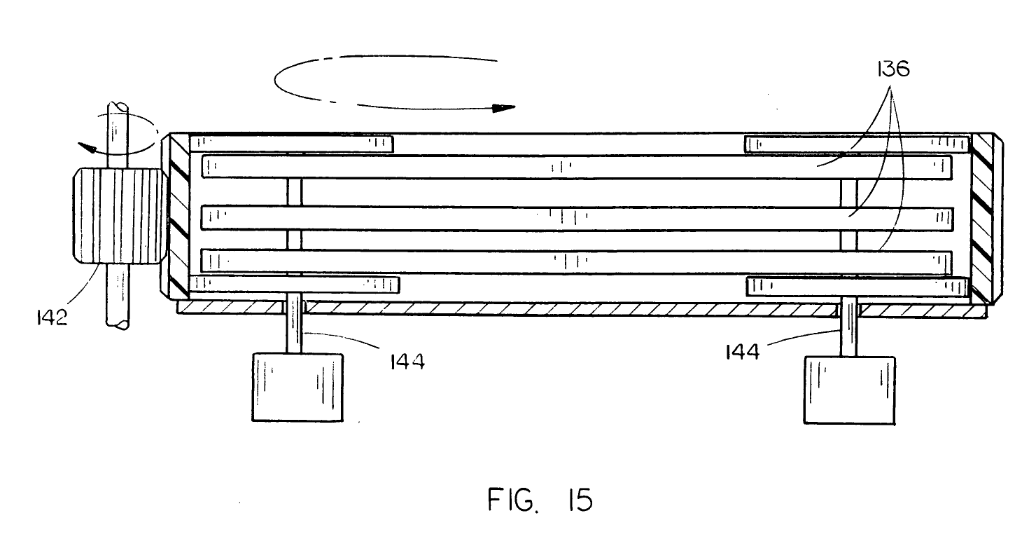

Referring generally to FIGS. 1 through 16, a magnetic motion apparatus 100 for converting energy in a first form to energy in a second form is shown. Magnetic motion apparatus 100 may convert electrical energy to mechanical energy, similar to operation of a motor. Additionally, magnetic motion apparatus 100 may convert mechanical energy to electrical energy, similar to a generator.

Magnetic motion apparatus 100 may include a stator 102 and a rotor 104 rotationally disposed of the stator 102. For example, the stator 102 may include a frame 106 for supporting the rotor 104. Rotor 104 may be rotationally coupled with the frame 106. In specific embodiments, the rotor 104 includes an axle, such as a shaft 108, which is rotationally coupled with the frame 106 via shaft bearings 110. The shaft bearings 110 may be ball bearings, roller bearings, or any other suitable machine parts for supporting the axle and reducing friction between the shaft 108 and the stator 102. The shaft 108 of the rotor 104 has a first end 112 and a second end 114. The first end of the rotor 112 includes a cam 116, such as a generally circular rotating member having a radial projection 118. The cam 116 is designed such that rotation of the cam 116 alternately causes an increase and a decrease in a radial dimension of the cam 116 with respect to a fixed reference, such as with respect to the frame 106 of the stator 102. For the purposes of this discussion, the increase in the radial dimension of the cam 116 corresponds to the radial projection 118.

In one specific embodiment, the second end of the rotor 114 includes a plurality of permanent magnets fixedly attached to the rotor 104, such as a set of magnets 120 fixedly attached to a support 122, which is fixedly attached to the shaft 108. In another specific embodiment, the second end of the rotor 114 may include a plurality of electromagnets fixedly attached to the rotor 104, such as the set of magnets 120 fixedly attached to the support 122. An electromagnet may refer to a core of ferromagnetic material at least partially enclosed by a coil of wire. In some embodiments, the coil of wire may be fixedly attached to the support 122 of rotor 104. In other embodiments, the core of ferromagnetic material is fixedly attached to the support 122 of rotor 104. In either of these configurations, the core of ferromagnetic material and the coil of wire are arranged so that an electric current in the coil of wire generates an electromagnetic field 124, while relative motion between the core of ferromagnetic material and the coil of wire, such as oscillation of the ferromagnetic material within the coil of wire, creates a changing magnetic field and generates electric current in the coil of wire for supply of electrical energy in an embodiment of a generator. Alternatively, the magnetic field 124 may be generated by the permanent magnets.

The stator 102 includes a number of levers 126 pivotally connected to the frame 106 surrounding the rotor 104. Each lever 126 has a first end 128 and a second end 130. The first end of each lever 128 includes a roller 132, such as a cam follower roller, or the like. The cam 116 is designed such that the rollers 132 are adjacent to and travel along the cam 116. Thus, the radial projection 118 (i.e., the alternate increases in the radial dimension of the cam 116 with respect to the frame 106) causes the levers 126 to pivot relative to the frame 106 as the cam 116 rotates. In this manner, the radial projections 118 cause the second end 130 of the lever 126 to alternately move closer to the set of magnets 120.

In one specific embodiment, the second end of each lever 126 includes a permanent magnet fixedly attached to the lever 130 and proximal to the set of magnets 120 fixedly attached to the support 122, such as a magnet 134. In another specific embodiment, the second end 130 of each lever 126 includes an electromagnet fixedly attached to the lever 12. In some embodiments, a coil of wire is fixedly attached to the lever 126. In other embodiments, a core of ferromagnetic material is fixedly attached to the lever 126. In either of these configurations, the core of ferromagnetic material and the coil of wire are arranged so that an electric current in the coil of wire generates an electromagnetic field 124, while relative motion between the core of ferromagnetic material and the coil of wire, such as oscillation of the ferromagnetic material within the coil of wire, creates a changing magnetic field and generates electric current in the coil of wire. Alternatively, the magnetic field 124 may be generated by the permanent magnets.

In specific embodiments, the magnetic device 100 is configured so that proximal ends of the set of magnets 120 fixedly attached to the support 122 and the magnets 134 disposed at the ends of each one of the levers 126 are repelled by one another. For example, like poles of set of magnets 120 attached to support may be placed in proximity with magnets 134 attached to each lever 126. Magnets may comprise pairs of poles (for example, north pole and south pole) whereby a first magnet with a north pole is placed in proximity with a second magnet with a north pole, causing magnetic repulsion. To further facilitate this arrangement, each individual magnet of the set of magnets 120 alternates with a radial projection 118 of the cam 116, i.e., the alternate increases in the radial dimension of the cam 116 with respect to the frame 106 alternate with each magnet. While repulsion may be employed, it is contemplated that magnetic motion apparatus may employ magnetic attraction without departing from the scope and intent of the present invention. Additionally, combination and variation of magnetic repulsion and attraction may be employed by the magnetic motion apparatus without departing from the scope and intent of the present invention.

In one specific embodiment, magnetic motion apparatus 100 is utilized as a magnetic motor. For example, the forces between the set of magnets 120 on the rotor 104 and the magnets 134 on the levers 126 cause the rollers 132 to engage and travel along the cam 116, converting electrical energy supplied to the magnets to mechanical energy that can be collected from the rotation of the shaft 108. In another specific embodiment, the magnetic device 100 is utilized as a magnetic generator. For instance, rotation of the shaft 108 combined with the forces between the set of magnets 120 on the rotor 104 and the magnets 134 on the levers 126 causes the magnets 134 disposed at the ends of each one of the levers 126 to oscillate, generating electric current within coils surrounding ferromagnetic material and converting mechanical energy into electrical energy.

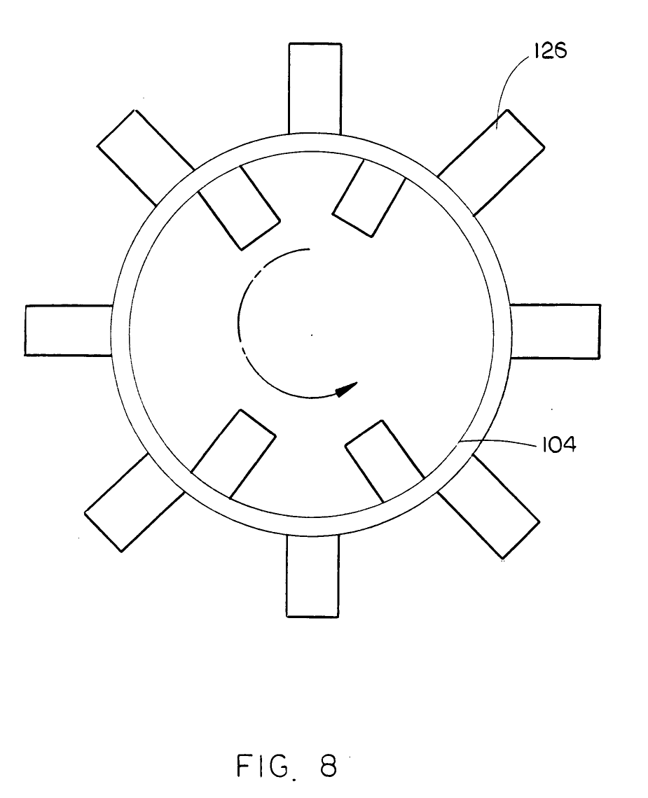

Referring to FIGS. 8-11G, exemplary rotation produced by the magnetic motion apparatus 100 is shown. In an embodiment of the invention, magnetic motion apparatus 100 may operate by causing rotor 104 to rotate while stator 102 remains stationary. It is contemplated that in alternative embodiments, magnetic motion apparatus 100 is configured so that the rotor 104 remains stationary while the stator 102 rotates respective to the rotor 104. In another embodiment, the magnetic motion apparatus 100 is configured so that the rotor 104 rotates in one direction while the stator 102 rotates in a direction opposite to the rotation of the rotor 104. In yet another embodiment, one or more cams 116 are fixedly attached to the shaft 108, each cam being positioned so that an additional number of levers 126 may be used in conjunction with an additional rotor 104. In one embodiment, a first cam 116 is attached to the shaft 108 offset from the second cam 116 attached to the shaft 108 allowing for a second number of levers 126 to be pivotally connected to the stator 102 in an alternate fashion between the first number of levers 126. In another embodiment, a second cam 116 is attached to the shaft 108 such that the perimeter of the second cam 116 extends beyond the perimeter of the first cam 116 allowing for a second number of levers 126 to be pivotally connected to the stator 102 such that the second number of levers 126 is aligned with the perimeter of the second cam 116. In another embodiment, more than two cams 116 and more than two sets of levers 126 are combined within the magnetic motion apparatus 100.

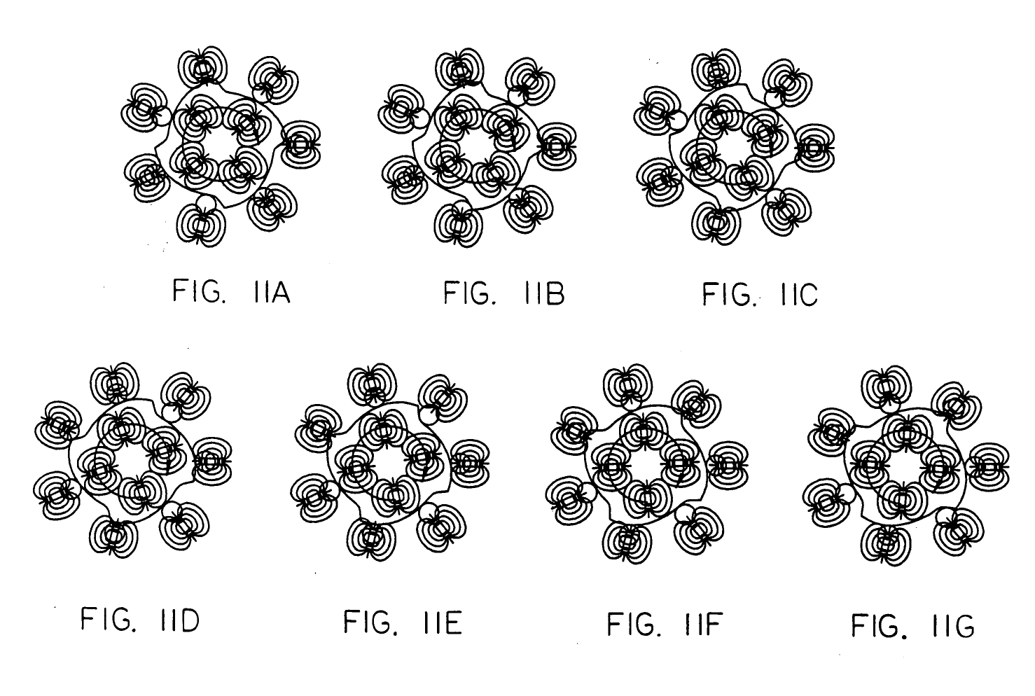

In another embodiment, the plurality of levers 126 is pivotally attached to a rotating track 136 wherein the track is coupled to the stator via bearings 110. The bearings 110 may be ball bearings, roller bearings, or any other suitable machine parts for supporting the track and reducing friction between the track 136 and the stator 102. Additionally, radial projections 118 are fixedly attached to the stator 102 to pivot the number of levers 126 as the number of levers 126 translate around the stator 102 on the track 136. Additionally, within the stator 102 is a rotor 104 fixedly attached to a shaft 108 wherein the track 136 rotates relative to the rotor 104. In another embodiment, the track 136 rotates in a first direction while the rotor 104 rotates in a second direction opposite to the first direction of the track 136. In another embodiment, the rotor 104 is attached to a second end 114 of the shaft 108 while a generator 138 or other unit capable of utilizing the mechanical output from the magnetic device 100 is attached to a first end 112 of the shaft 108. Referring to FIGS. 11A-11G, exemplary rotary motion of the rotor and the offset position of levers to provide continuous rotational force in accordance with an embodiment of the present invention is shown.

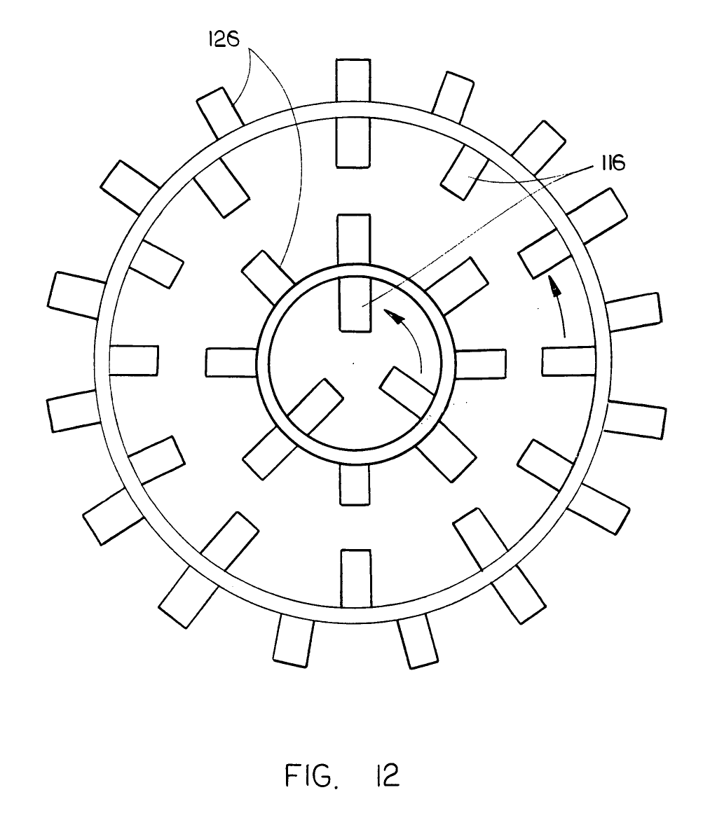

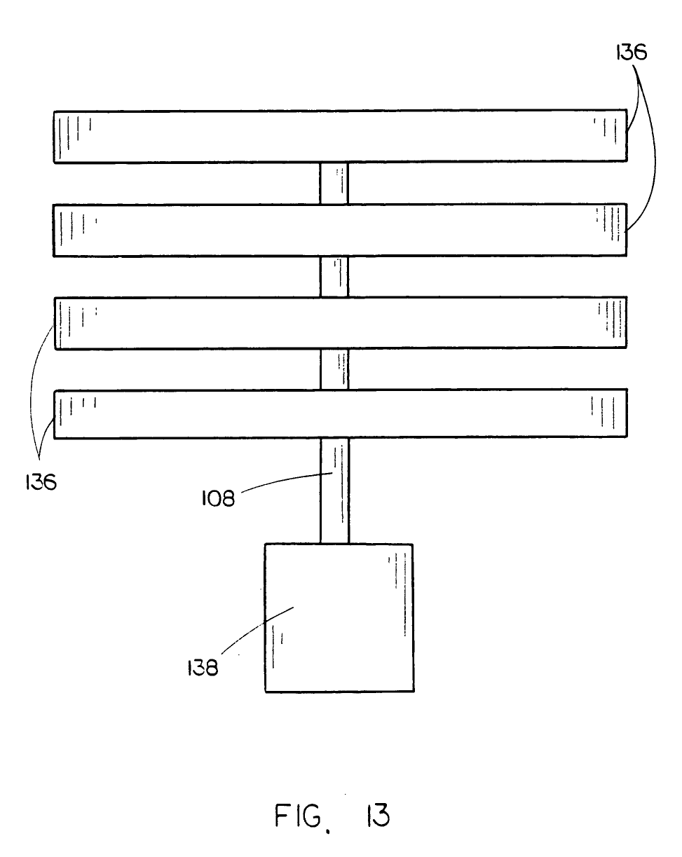

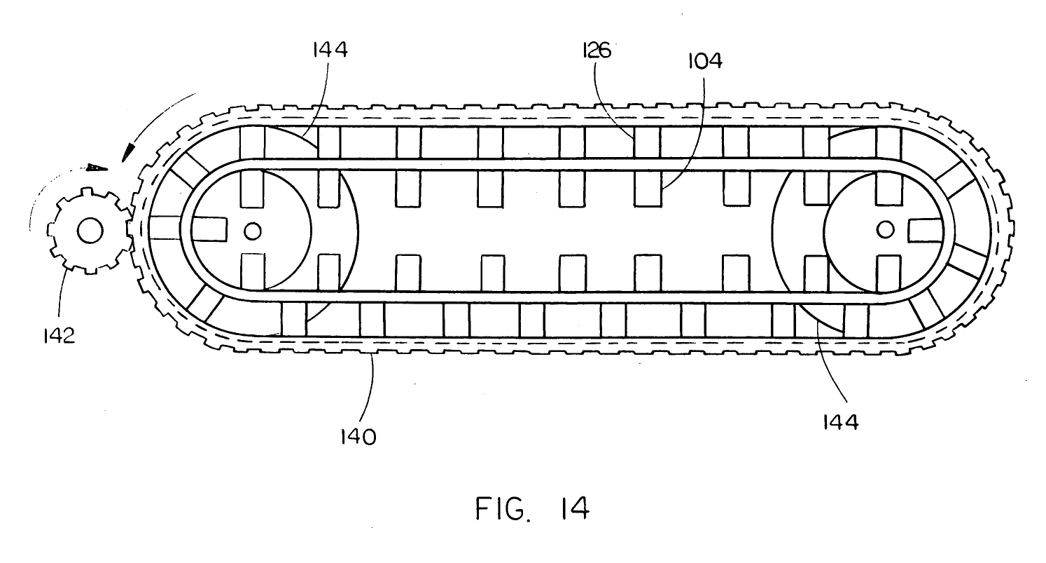

Referring to FIGS. 12-15, a magnetic motion apparatus 100 in accordance with alternative embodiments is shown. Multiple tracks 136 may be incorporated in magnetic motion apparatus 100. For example, in addition to the previous embodiment, a second track 136, including an additional number of levers 126 may be coupled to the exterior of the stator 102 via bearings 110. The bearings 110 may be ball bearings, roller bearings, or any other suitable machine parts for supporting the track and reducing friction between the track 136 and the exterior of the stator 102. Additionally, a second set of radial projections 118 is included to pivot the number of levers 126 as the number of levers 126 translate around the exterior of the stator 102 on the second track 136. In another embodiment, the mechanical device 100 may include more than two tracks 136, each including a number of levers 126 and more than two sets of radial projections 118. In another embodiment, dimension to the motor may be increased by adding additional magnets 134 to the number of levers 126 in a vertical manner. Additionally, dimension to the motor is increased by adding additional magnets 120 to the rotor 104 in a vertical manner.

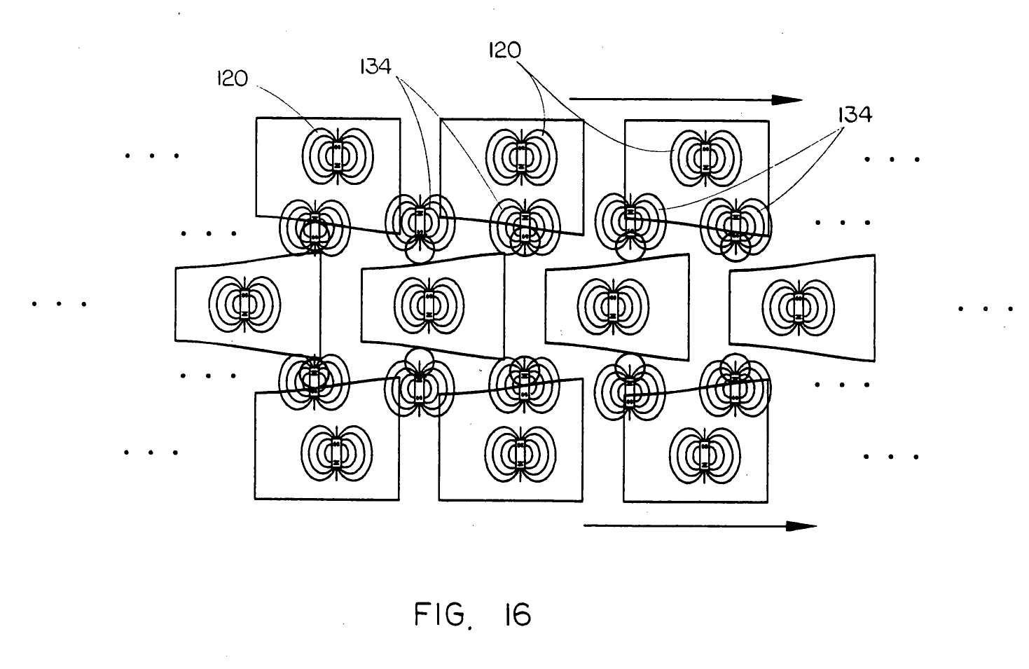

Referring to FIGS. 14-15, a magnetic motion apparatus 100 may include a set of gears 142, rotated on a belt device, for rotating a cog 142. Magnetic motion apparatus 100 may include drums 144 in which the belt device including a set of gears may rotate. It is contemplated that belt drive may be used in place or, or in combination with, shaft 108 according to various embodiments of the present invention.

In one embodiment, the magnetic motion apparatus 100 may be turned off by removing the magnetic repulsion. For example, in various embodiments of the present invention, magnets 120 and/or 134 may be pivoted, raised and/or lowered thereby disrupting their proximal relationship to the other magnets of the system. In another embodiment, magnets 1 and/or 134 are attached so that they rotate up and down and side to side so that they continue to face each other while they are moving past one another. This would allow more compact arrangements, more power output per area used and the ability to use flatter magnets.

In another embodiment a non-magnetic shield is positioned and attached to the rotor 104 to prevent the repulsion of the magnet 134 from the magnet 120 where the magnet 134 is brought within proximity of the magnet 120. For example, when the roller 132 is moving away from the radial projection 118, the roller's magnet 134 is brought within close proximity to the magnet 120. This close proximity may result in an undesirable slowing of the roller's 132 descent from the radial projection 118 thereby slowing magnetic motion apparatus 100. To counter this slowing, a magnetic shield is attached to the rotor 104 and positioned to block the magnetic repulsion at the point of descent.

Referring now to FIG. 16, an exemplary embodiment is illustrated in which two rows of levers, including rollers at one end and magnets 134 at another end, are positioned between three rows of cams, including magnets 120. The rollers at one end of each lever are adjacent to and travel along the cams, and the magnets 134 at the other end of each lever are proximal to the magnets 120. In this configuration, the cams and their associated magnets 120 may translate together in a linear direction relative to the levers including the magnets 134. For example, the cams may be fixedly attached to a belt and the magnets 120 may be fixedly attached to either the belt or the cams. In this manner, the cam magnets 120 positioned between the lever magnets 134, together with the cam magnets 120 positioned on the outside of the lever magnets 134, may alternately repel the lever magnets 134, causing the levers to pivot in a pendulum-like manner. In this manner, the repelling forces between the cam magnets 120 and the lever magnets 134 may cause the rollers at the end of each lever to alternately exert forces on the cams positioned between the levers and the cams positioned on the outside of the levers, moving the three rows of cams including the magnets 120 in a linear direction with relation to the two rows of levers. It will be appreciated that more or fewer rows of magnets and cams may be included without departing from the scope of the present invention.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A magnetic motion apparatus for converting energy, comprising:
a stator having a frame;
a rotor rotationally coupled with the frame, the rotor having a first end including a cam and a second end including a plurality of magnets fixedly attached to the rotor; and
a plurality of levers pivotally connected to the frame surrounding the rotor, each one of the plurality of levers having a first end including a roller adjacent to the cam, and a second end including a core of ferromagnetic material at least partially enclosed by a coil of wire proximal to the plurality of magnets;
wherein the plurality of magnets fixedly attached to the rotor is arranged so that proximal ends of the plurality of magnets and the ferromagnetic material at least partially enclosed by the coil of wire are repelled by one another,
wherein each one of the plurality of magnets alternates with a radial projection of the cam,
wherein energy of a first form is converted to energy of a second form through rotation of said cam.

2. The magnetic motion apparatus as claimed in claim 1, wherein electrical energy is converted to mechanical energy.

3. The magnetic motion apparatus as claimed in claim 1, wherein mechanical energy is converted to electrical energy.

4. The magnetic motion apparatus as claimed in claim 1, wherein the plurality of magnets fixedly attached to the rotor comprises permanent magnets.

5. The magnetic motion apparatus as claimed in claim 1, wherein the plurality of magnets fixedly attached to the rotor comprises electromagnets.

6. The magnetic motion apparatus as claimed in claim 5, said electromagnets comprise ferromagnetic material at least partially enclosed by a coil of wire.

7. The magnetic motion apparatus as claimed in claim 6, wherein said ferromagnetic material is coupled to said rotor.

8. The magnetic motion apparatus as claimed in claim 6, wherein said coil of wire is coupled to said rotor.

9. A magnetic motor, comprising:
a stator having a frame;
a rotor rotationally coupled with the frame, the rotor having a first end including a cam and a second end including a plurality of magnets fixedly attached to the rotor; and
a plurality of levers pivotally connected to the frame surrounding the rotor, each one of the plurality of levers having a first end including a roller adjacent to the cam, and a second end including a core of ferromagnetic material at least partially enclosed by a coil of wire proximal to the plurality of magnets;
wherein the plurality of magnets fixedly attached to the rotor is arranged so that proximal ends of the plurality of magnets and the ferromagnetic material at least partially enclosed by the coil of wire are repelled by one another,
wherein each one of the plurality of magnets alternates with a radial projection of the cam,
wherein electrical energy is converted to mechanical energy through rotation of said cam.

10. The magnetic motor as claimed in claim 9, wherein the plurality of magnets fixedly attached to the rotor comprises permanent magnets.

11. The magnetic motor as claimed in claim 9, wherein the plurality of magnets fixedly attached to the rotor comprises electromagnets.

12. The magnetic motor as claimed in claim 11, said electromagnets comprise ferromagnetic material at least partially enclosed by a coil of wire.

13. The magnetic motor as claimed in claim 12, wherein said ferromagnetic material is coupled to said rotor.

14. The magnetic motor as claimed in claim 12, wherein said coil of wire is coupled to said rotor.

15. A generator, comprising:
a stator having a frame;
a rotor rotationally coupled with the frame, the rotor having a first end including a cam and a second end including a plurality of magnets fixedly attached to the rotor; and
a plurality of levers pivotally connected to the frame surrounding the rotor, each one of the plurality of levers having a first end including a roller adjacent to the cam, and a second end including a core of ferromagnetic material at least partially enclosed by a coil of wire proximal to the plurality of magnets;
wherein the plurality of magnets fixedly attached to the rotor is arranged so that proximal ends of the plurality of magnets and the ferromagnetic material at least partially enclosed by the coil of wire are repelled by one another,
wherein each one of the plurality of magnets alternates with a radial projection of the cam,
wherein mechanical energy is converted to electrical energy through rotation of said cam.

16. The generator as claimed in claim 15, wherein the plurality of magnets fixedly attached to the rotor comprises permanent magnets.

17. The generator as claimed in claim 15, wherein the plurality of magnets fixedly attached to the rotor comprises electromagnets.

18. The generator as claimed in claim 17, said electromagnets comprise ferromagnetic material at least partially enclosed by a coil of wire.

19. The generator as claimed in claim 18, wherein said ferromagnetic material is coupled to said rotor.

20. The generator as claimed in claim 18, wherein said coil of wire is coupled to said rotor.
